(19) United States
(12) Patent Application Publication
(10) Pub. No.: US 2020/0044298 A1
(43) Pub. Date: Feb. 6, 2020

(54) BATTERY FOR ELECTRIFIED VEHICLE AND CORRESPONDING METHOD OF ACCOMMODATING FOR VARIABLE CELL THICKNESS

(71) Applicant: Ford Global Technologies, LLC, Dearborn, MI (US)

(72) Inventors: Rajaram Subramanian, Ann Arbor, MI (US); Saravanan Paramasivam, South Lyon, MI (US); Kimberley King, Northville, MI (US); Amar Marpu, Canton, MI (US); Bhaskara Boddakayala, Troy, MI (US); Steve F. Chorian, Canton, MI (US); Nihar Kotak, Farmington Hills, MI (US)

(21) Appl. No.: 16/055,222

(22) Filed: Aug. 6, 2018

(51) Int. Cl. H01M 10/625; H01M 10/647; H01M 10/653; H01M 2/10; H01M 10/04; H01M 2/16

(52) U.S. Cl. CPC H01M 10/625; H01M 10/647; H01M 10/653; H01M 2220/20; H01M 10/0468; H01M 2/16; H01M 2/1077

(57) ABSTRACT

This disclosure relates to a battery for an electrified vehicle and a corresponding method. In particular, the battery and method accommodate for variable cell thickness. An example method of this disclosure includes inserting a separator between a first battery cell and a second battery cell. The separator has a thickness based on a thickness of the first battery cell and the second battery cell. This disclosure has a number of benefits. Among them, the method may be used to provide a battery array with a desired overall length despite differences in individual cell thickness. In turn, this leads to improved battery performance and lifespan.

### TECHNICAL FIELD

This disclosure relates to a battery for an electrified vehicle and a corresponding method. In particular, the battery and method accommodate for variable cell thickness.

### BACKGROUND

The need to reduce automotive fuel consumption and emissions is well known. Therefore, vehicles are being developed that reduce reliance on internal combustion engines. Electrified vehicles are one type of vehicle being developed for this purpose. In general, electrified vehicles differ from conventional motor vehicles in that electrified vehicles are selectively driven using one or more electric machines powered by a first power supply, namely a traction battery. The electric machines can drive the electrified vehicles instead of, or in addition to, a second power supply, such as an internal combustion engine. Example electrified vehicles include hybrid electric vehicles (HEVs), plug-in hybrid electric vehicles (PHEVs), fuel cell vehicles (FCVs), and battery electric vehicles (BEVs).

### SUMMARY

A method according to an exemplary aspect of the present disclosure includes, among other things, inserting a separator between a first battery cell and a second battery cell. The separator has a thickness based on a thickness of the first battery cell and the second battery cell.

In a further non-limiting embodiment of the foregoing method, the thickness of the separator is based on a sum of the thicknesses of the first battery cell and the second battery cell.

In a further non-limiting embodiment of any of the foregoing methods, the thicknesses of the first and second battery cells are determined by measuring the battery cells.

In a further non-limiting embodiment of any of the foregoing methods, the thicknesses of the first and second battery cells are determined by scanning a machine-readable indicator on the first and second battery cells.

In a further non-limiting embodiment of any of the foregoing methods, the separator is selected from a plurality of separators having varying thicknesses.

In a further non-limiting embodiment of any of the foregoing methods, when the sum of the thicknesses of the first and second battery cells is above a predetermined range, a separator of a first thickness is inserted between the first battery cell and the second battery cell.

In a further non-limiting embodiment of any of the foregoing methods, when the sum of the thicknesses of the first and second battery cells is within a predetermined range, a separator of a second thickness is inserted between the first battery cell and the second battery cell. The second thickness is greater than the first thickness.

In a further non-limiting embodiment of any of the foregoing methods, when the sum of the thicknesses of the first and second battery cells is below a predetermined range, a separator of a third thickness is inserted between the first battery cell and the second battery cell. The third thickness is greater than the second thickness.

In a further non-limiting embodiment of any of the foregoing methods, the thickness of the separator is selected in order to achieve a predetermined array length. Further, the array includes the first battery cell, the second battery cell, and a plurality of other battery cells.

In a further non-limiting embodiment of any of the foregoing methods, separators of varying thicknesses are inserted between adjacent ones of the plurality of battery cells based on a thickness of the adjacent battery cells to achieve the desired array length.

In a further non-limiting embodiment of any of the foregoing methods, the separator is a foam pad.

In a further non-limiting embodiment of any of the foregoing methods, the separator is provided by a metal foam material.

A motor vehicle according to an exemplary aspect of the present disclosure includes, among other things, an array including a plurality of battery cells and a plurality of separators between adjacent ones of the battery cells. Each of the separators have a thickness based on a thickness of the respective adjacent ones of the battery cells.

In a further non-limiting embodiment of the foregoing motor vehicle, each of the separators have a thickness based on a sum of the thicknesses of the respective adjacent ones of the battery cells.

In a further non-limiting embodiment of any of the foregoing motor vehicles, each of the separators are selected from a plurality of separators having varying thicknesses.

In a further non-limiting embodiment of any of the foregoing motor vehicles, when the sum of the thicknesses of the adjacent battery cells is above a predetermined range, the separator between the adjacent battery cells has a first thickness, when the sum of the thicknesses of the adjacent battery cells is within a predetermined range, the separator between the adjacent battery cells has a second thickness greater than the first thickness, and when the sum of the thicknesses of the adjacent battery cells is below a predetermined range, the separator between the adjacent battery cells has a third thickness greater than the second thickness.

In a further non-limiting embodiment of any of the foregoing motor vehicles, the separators are of varying thicknesses and, together with the plurality of battery cells, the separators provide the array with a length within a predetermined range.

In a further non-limiting embodiment of any of the foregoing motor vehicles, the separators are provided by foam pads.

In a further non-limiting embodiment of any of the foregoing motor vehicles, each of the plurality of battery cells includes a machine-readable indicator including information about the thickness of the respective battery cell.

In a further non-limiting embodiment of any of the foregoing motor vehicles, the battery cells are pouch cells.

### BRIEF DESCRIPTION OF THE DRAWINGS

FIG. 1 schematically illustrates a powertrain of an electrified vehicle.

FIG. 2 illustrates an example array of battery cells from a top view.

FIG. 3 is a flow chart representative of an example method according to this disclosure.

FIG. 4A illustrates a first and second battery cell having a thickness sum above a predetermined range, and a separator having a first thickness.

FIG. 4B illustrates a first and second battery cell having a thickness sum within a predetermined range, and a separator having a second thickness greater than the first thickness.

FIG. 4C illustrates a first and second battery cell having a thickness sum below a predetermined range, and a separator having a third thickness greater than the second thickness.

### DETAILED DESCRIPTION

This disclosure relates to a battery for an electrified vehicle and a corresponding method. In particular, the battery and method accommodate for variable cell thickness. An example method of this disclosure includes inserting a separator between a first battery cell and a second battery cell. The separator has a thickness based on a thickness of the first battery cell and the second battery cell. This disclosure provides a number of benefits which will be appreciated from the below discussion. Among them, the method may be used to provide a battery array with a desired overall length despite differences in individual cell thickness. In turn, this leads to improved battery performance and increased lifespan.

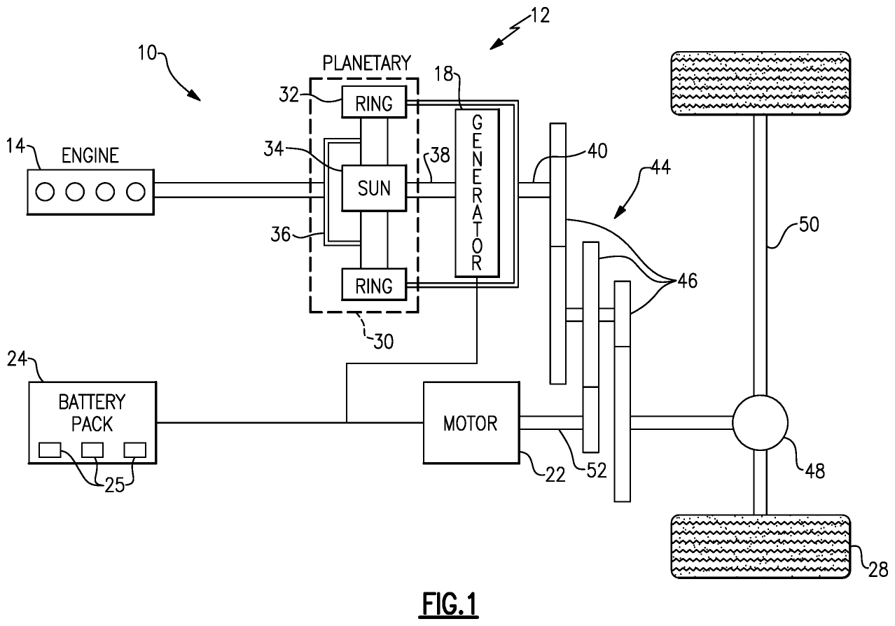

Referring to the drawings, FIG. 1 schematically illustrates a powertrain 10 for a motor vehicle, which in this example is an electrified vehicle 12. Although depicted as a hybrid electric vehicle (HEV), it should be understood that the concepts described herein are not limited to HEVs and could extend to other electrified vehicles, including, but not limited to, plug-in hybrid electric vehicles (PHEVs) and battery electric vehicles (BEVs).

In a non-limiting embodiment, the powertrain 10 is a power-split powertrain system that employs a first drive system and a second drive system. The first drive system includes a combination of an engine 14 and a generator 18 (i.e., a first electric machine). The second drive system includes at least a motor 22 (i.e., a second electric machine), the generator 18, and a battery pack 24. In this example, the second drive system is considered an electric drive system of the powertrain 10. The first and second drive systems generate torque to drive one or more sets of vehicle drive wheels 28 of the electrified vehicle 12. Although a power-split configuration is depicted in FIG. 1, this disclosure extends to any hybrid or electric vehicle including full hybrids, parallel hybrids, series hybrids, mild hybrids, micro hybrids, plug-in hybrids, and battery electric vehicles. This disclosure also extends to motor vehicles that are not electrified vehicles, including motor vehicles having only an internal combustion engine.

The engine 14, which in one embodiment is an internal combustion engine, and the generator 18 may be connected through a power transfer unit 30, such as a planetary gear set. Of course, other types of power transfer units, including other gear sets and transmissions, may be used to connect the engine 14 to the generator 18. In one non-limiting embodiment, the power transfer unit 30 is a planetary gear set that includes a ring gear 32, a sun gear 34, and a carrier assembly 36.

The generator 18 can be driven by the engine 14 through the power transfer unit 30 to convert kinetic energy to electrical energy. The generator 18 can alternatively function as a motor to convert electrical energy into kinetic energy, thereby outputting torque to a shaft 38 connected to the power transfer unit 30. Because the generator 18 is operatively connected to the engine 14, the speed of the engine 14 can be controlled by the generator 18.

The ring gear 32 of the power transfer unit 30 may be connected to a shaft 40, which is connected to vehicle drive wheels 28 through a second power transfer unit 44. The second power transfer unit 44 may include a gear set having a plurality of gears 46. Other power transfer units may also be suitable. The gears 46 transfer torque from the engine 14 to a differential 48 to ultimately provide traction to the vehicle drive wheels 28. The differential 48 may include a plurality of gears that enable the transfer of torque to the vehicle drive wheels 28. In one embodiment, the second power transfer unit 44 is mechanically coupled to an axle 50 through the differential 48 to distribute torque to the vehicle drive wheels 28.

The motor 22 can also be employed to drive the vehicle drive wheels 28 by outputting torque to a shaft 52 that is also connected to the second power transfer unit 44. In one embodiment, the motor 22 and the generator 18 cooperate as part of a regenerative braking system in which both the motor 22 and the generator 18 can be employed as motors to output torque. In another example, the motor 22 and the generator 18 can each output electrical power to the battery pack 24.

The battery pack 24 is an exemplary electrified vehicle battery. The battery pack 24 may be a high voltage traction battery pack that includes a plurality of battery assemblies 25 (i.e., battery arrays or groupings of battery cells) capable of outputting electrical power to operate the motor 22, the generator 18 and/or other electrical loads of the electrified vehicle 12 via an electrical distribution system. Other types of energy storage devices and/or output devices could also be used to electrically power the electrified vehicle 12.

In a non-limiting embodiment, the electrified vehicle 12 has two basic operating modes. The electrified vehicle 12 may operate in an Electric Vehicle (EV) mode where the motor 22 is used (generally without assistance from the engine 14) for vehicle propulsion, thereby depleting the battery pack 24 state of charge up to its maximum allowable discharging rate under certain driving patterns/cycles. The EV mode is an example of a charge depleting mode of operation for the electrified vehicle 12. During EV mode, the state of charge of the battery pack 24 may increase in some circumstances, for example due to a period of regenerative braking. The engine 14 is generally OFF under a default EV mode but could be operated as necessary based on a vehicle system state or as permitted by the operator.

The electrified vehicle 12 may additionally operate in a Hybrid (HEV) mode in which the engine 14 and the motor 22 are both used for vehicle propulsion. The HEV mode is an example of a charge sustaining mode of operation for the electrified vehicle 12. During the HEV mode, the electrified vehicle 12 may reduce the motor 22 propulsion usage in order to maintain the state of charge of the battery pack 24 at a constant or approximately constant level by increasing the engine 14 propulsion. The electrified vehicle 12 may be operated in other operating modes in addition to the EV and HEV modes within the scope of this disclosure.

In one example of this disclosure, the battery assemblies 25 are provided by arrays of pouch cells. Pouch cells are known and employ a laminated architecture within a bag. In particular, pouch cells are known to include conductive foil tabs welded to an electrode, which is sealed within a pouch. The tabs carry the positive and negative terminals to the outside. Pouch cells offer a relatively simple, flexible and lightweight battery design. Pouch cells may swell as a result of gas generation during charge and discharge. While pouch cells do not include a metal enclosure, which reduces weight, pouch cells typically need additional support in the battery compartment. The detail of an arrangement providing such support is described in detail below. This disclosure is not limited to pouch cells, however, and extends to other battery assemblies 25 that may experience swelling and that may be affected by cell thickness tolerances, as will be appreciated from the below.

FIG. 2 illustrates, somewhat schematically, an example battery assembly 25 from a top view. In this example, the battery assembly 25 is an array 60 having a length L extending between opposed first and second end plates 62, 64 and a width W normal to the length L.

The array 60 includes a plurality of battery cells 66 and a plurality of separators 68 between adjacent battery cells 66. The battery cells 66 in this example are pouch cells, but, again, this disclosure is not limited to pouch cells. The separators 68 may be made of a foam material, such as a closed cell metal foam material. Further, the separators 68 may be made of a thermally insulative material.

In addition to the battery cells 66 and separators 68, the array 60 also includes a frame 70 extending between the end plates 62, 64 and configured to thermally manage the battery cells 66. The frame 70 may be made of a thermally conductive material, such as metal. In this example, the frame 70 provides a number of compartments 72, each of which includes two battery cells and a separator between the adjacent battery cells. There are two exceptions in this example. Specifically, the compartments 72 adjacent the end plates 62, 64 include only a single battery cell 66 and a separator 68 between the respective end plate 62, 64 and the battery cell 66.

In this disclosure, the frame 70 and compartments 72 are arranged such that each of the battery cells 66 contacts a portion of the frame 70 for thermal management (i.e., cooling) purposes. It should be understood that each of the compartments 72 could include one or more battery cells and one or more separators. Further, it should be understood that this disclosure is not limited to the details of the frame 70 or the compartments 72.

The battery cells 66 have a thickness T₁, and the battery cells 66 are arranged within the array 60 such that their thicknesses T₁ are parallel to the length L. Likewise, the separators 68 have a thickness T₂, and the separators 68 are arranged such that their thicknesses T₂ are also parallel to the length L and the thickness T₁.

Given inherent imperfections in manufacture and assembly processes, the battery cells 66 within the array 60 may exhibit different thicknesses T₁. In one example, the battery cells 66 are manufactured such that they exhibit a thickness T₁ within a predetermined tolerance range. However, even when each of the battery cells 66 have a thickness T₁ within the predetermined tolerance range, the different thicknesses of the battery cells 66 may cause the array 60 to have a non-uniform length L when compared to other arrays. Alternatively or in addition, the array 60 (including the separators 68 and the frame 70) may not be applying appropriate forces onto the battery cells 66 for optimal performance and life.

For instance, if the battery cells 66, on average, have thicknesses T₁ on a lower end of the predetermined tolerance range, the overall length L of the array 60 may be reduced, and alternatively or in addition the battery cells 66 may not have sufficient forces applied at beginning of life (BOL) thereto to adequately ensure cell performance, for example. Likewise, if the thicknesses T₁ are on a higher end of a tolerance range, the overall length L of the array may be increased, and the battery cells 66 may have excess forces applied thereto.

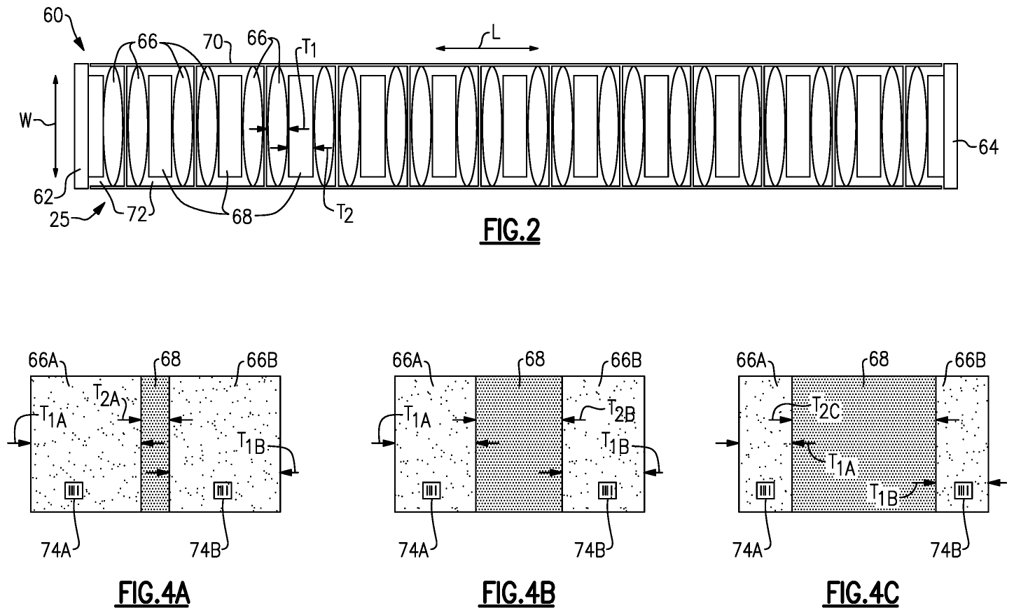

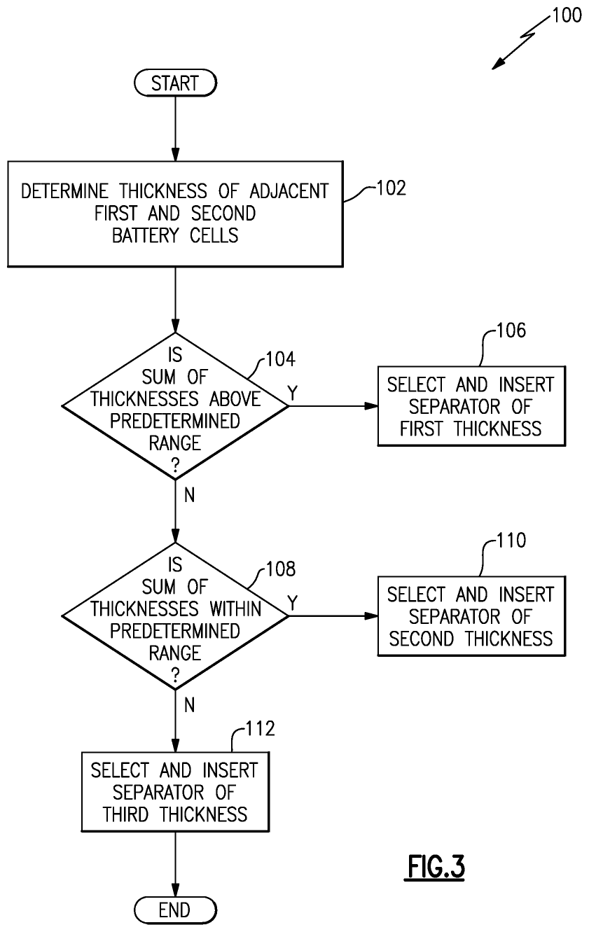

Accordingly, in this disclosure, the thicknesses T₂ of the separators 68 are selected to account for differences in the thicknesses T₁, in order to provide the array 60 with a desired overall length L and to apply appropriate forces onto the battery cells 66. The array 60 may include a plurality of separators 68 of varying thicknesses T₂, meaning that at least some of the separators 68 have a different thickness T₂. An example method of selecting an appropriate thickness T₂ for the separators 68 will now be explained with reference to the FIG. 3 and the illustrations of FIGS. 4A-4C.

FIG. 3 is a flow chart representative of an example method 100. In the method 100, the thicknesses T₁ of adjacent battery cells 66 are determined, at 102. With reference to the example of FIG. 4A, a first battery cell 66A has a first thickness T_{1A} and a second, adjacent battery cell 66B has a second thickness T_{1B}. The thicknesses T_{1A}, T_{1B} may be determined by a worker, such as an assembly line worker, directly using a measurement instrument such as calipers, or by scanning a respective machine-readable indicator 74A, 74B. In this example, the machine-readable indicators 74A, 74B are provided by barcodes, QR codes, RFID chips or tags, or the like. The machine-readable indicators 74A, 74B may include data indicative of the thicknesses T_{1A}, T_{1B} of the respective first and second battery cells 66A, 66B. This disclosure is not limited to any particular technique for determining the thicknesses T_{1A}, T_{1B}, and extends to other techniques.

With the thicknesses T_{1A}, T_{1B} of the first and second battery cells 66A, 66B determined, an appropriate thickness of the separator 68 may be selected. As mentioned above, the thickness of the separator 68 is based on the thicknesses of the adjacent battery cells 66 in order to provide the array 60 with a desired overall length and to provide appropriate forces onto the battery cells. In the method 100, the thickness T₂ of the separator 68 is selected based on a sum of the thicknesses T_{1A}, T_{1B}. In one particular example, the sum of the thicknesses T_{1A}, T_{1B} is compared to a predetermined range, and a separator 68 of an appropriate thickness T₂ is selected and inserted between the first and second battery cells 66A, 66B depending on whether the separator 68 is above, within, or below the predetermined range.

For instance, at 104, if the sum of the thicknesses T_{1A}, T_{1B} is above the predetermined range, then, at 106, a separator 68 having a first thickness T_{2A} is selected and inserted between the first and second battery cells 66A, 66B. With reference to FIG. 4A, the thicknesses T_{1A}, T_{1B} are relatively large, and thus the sum of the two thicknesses T_{1A}, T_{1B} exceeds the predetermined range. Thus, a separator having a first thickness T_{2A} is selected and inserted between the first and second battery cells 66A, 66B.

In this disclosure, the decision in step 104 (and step 108) may be made by a worker, such as an assembly line worker, or by a computerized device such as a barcode scanner, QR code reader, RFID scanner, mobile phone, tablet, etc. The computerized device may be capable of reading the machine-readable indicators 74A, 74B, and may be configured to determine where the sum of the thicknesses T_{1A}, T_{1B} fall relative to the predetermined range. The computerized device may further be capable of displaying the sum of the thicknesses to a user, and may further be capable of suggesting to the user which thickness T₂ is appropriate for the separator 68.

To this end, a worker may have access to a plurality of groups of separators 68. In one example, there are three groups of separators 68. The separators 68 within a first group have each have a first thickness T_{2A} which is relatively thin. The separators 68 within a second group have a second thickness T_{2B} greater than the first thickness T_{2A}, and the separators 68 within a third group have a third thickness T_{2C} greater than the second thickness T_{2B}. The separators 68 may be arranged in bins corresponding to the various thicknesses, and a worker may select a separator 68 from an appropriate bin based on the sum of the thicknesses T_{1A}, T_{1B}.

Continuing with the method 100, if, at 108, the sum of the thicknesses T_{1A}, T_{1B} is within the predetermined range then, at 110, a separator 68 of a second thickness T_{2B} is selected and inserted between the first and second battery cells 66A, 66B, as generally illustrated in FIG. 4B. In FIG. 4B, the sum of the thicknesses T_{1A}, T_{1B} is less than the sum of the thicknesses T_{1A}, T_{1B} in the FIG. 4A example, and thus the separator 68 in FIG. 4B has a second thickness T_{2B} greater than that of the first thickness T_{2A} in FIG. 4A.

If, at 108, it is determined that the sum of the thicknesses is not within the predetermined range (i.e., the sum is below the predetermined range), then, at 112, a separator 68 of a third thickness T_{2C} is selected and inserted between the first and second battery cells 66A, 66B. With reference to FIG. 4C, the sum of the thicknesses T_{1A}, T_{1B} of the battery cells 66A, 66B is less than the sum calculated in the FIGS. 4A and 4B examples, and thus a separator 68 of a third thickness T_{2C} greater than the first and second thicknesses T_{2A}, T_{2B} is selected and inserted between the first and second battery cells 66A, 66B.

In this way, the combined thickness of the first and second battery cells 66A, 66B and the separators 68 is substantially the same in FIGS. 4A, 4B, and 4C. The method 100 is repeated for all adjacent sets of battery cells 66 within the array 60. The result is an array 60 that accounts for variability in battery cell thicknesses, which leads to a uniform array length. Further, more uniform forces are applied to the battery cells 66, which increases the lifespan of the battery cells 66.

A version of the method 100 may be performed adjacent the end walls 62, 64, in order to select an appropriately-sized separator 68 to fit between the end walls 62, 64 and the adjacent battery cell 66. In particular, the separators 68 adjacent the end walls may be selected as a final step of the method in order to achieve a desired overall length L of the array 60.

While three groups of separators 68 and a single predetermined range of thickness sums (i.e., the sums of T_{1A} and T_{1B}) are discussed above, it should be understood that the method 100 is exemplary only and modifications thereof come within the scope of this disclosure. For example, there could be two or more groups of separators, and one or more predetermined ranges of thickness sums, depending on the particular application.

It should be understood that terms such as “about,” “substantially,” and “generally” are not intended to be boundaryless terms, and should be interpreted consistent with the way one skilled in the art would interpret those terms.

Although the different examples have the specific components shown in the illustrations, embodiments of this disclosure are not limited to those particular combinations. It is possible to use some of the components or features from one of the examples in combination with features or components from another one of the examples. In addition, the various FIGS. accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A method, comprising:
inserting a separator between a first battery cell and a second battery cell, the separator having a thickness based on a thickness of the first battery cell and the second battery cell.

2. The method as recited in claim 1, wherein the thickness of the separator is based on a sum of the thicknesses of the first battery cell and the second battery cell.

3. The method as recited in claim 2, wherein the thicknesses of the first and second battery cells are determined by measuring the battery cells.

4. The method as recited in claim 2, wherein the thicknesses of the first and second battery cells are determined by scanning a machine-readable indicator on the first and second battery cells.

5. The method as recited in claim 1, wherein the separator is selected from a plurality of separators having varying thicknesses.

6. The method as recited in claim 5, wherein, when the sum of the thicknesses of the first and second battery cells is above a predetermined range, a separator of a first thickness is inserted between the first battery cell and the second battery cell.

7. The method as recited in claim 6, wherein, when the sum of the thicknesses of the first and second battery cells is within a predetermined range, a separator of a second thickness is inserted between the first battery cell and the second battery cell, the second thickness greater than the first thickness.

8. The method as recited in claim 7, wherein, when the sum of the thicknesses of the first and second battery cells is below a predetermined range, a separator of a third thickness is inserted between the first battery cell and the second battery cell, the third thickness greater than the second thickness.

9. The method as recited in claim 1, wherein the thickness of the separator is selected in order to achieve a predetermined array length, the array including the first battery cell, the second battery cell, and a plurality of other battery cells.

10. The method as recited in claim 9, wherein separators of varying thicknesses are inserted between adjacent ones of the plurality of battery cells based on a thickness of the adjacent battery cells to achieve the desired array length.

11. The method as recited in claim 1, wherein the separator is a foam pad.

12. The method as recited in claim 11, wherein the separator is provided by a metal foam material.

13. A motor vehicle, comprising:
an array including a plurality of battery cells and a plurality of separators between adjacent ones of the battery cells, wherein each of the separators have a thickness based on a thickness of the respective adjacent ones of the battery cells.

14. The motor vehicle as recited in claim 13, wherein each of the separators have a thickness based on a sum of the thicknesses of the respective adjacent ones of the battery cells.

15. The motor vehicle as recited in claim 14, wherein each of the separators are selected from a plurality of separators having varying thicknesses.

16. The motor vehicle as recited in claim 15, wherein:
when the sum of the thicknesses of the adjacent battery cells is above a predetermined range, the separator between the adjacent battery cells has a first thickness,
when the sum of the thicknesses of the adjacent battery cells is within a predetermined range, the separator between the adjacent battery cells has a second thickness greater than the first thickness, and
when the sum of the thicknesses of the adjacent battery cells is below a predetermined range, the separator between the adjacent battery cells has a third thickness greater than the second thickness.

17. The motor vehicle as recited in claim 13, wherein the separators are of varying thicknesses and, together with the plurality of battery cells, the separators provide the array with a length within a predetermined range.

18. The motor vehicle as recited in claim 13, wherein the separators are provided by foam pads.

19. The motor vehicle as recited in claim 13, wherein each of the plurality of battery cells includes a machine-readable indicator including information about the thickness of the respective battery cell.

20. The motor vehicle as recited in claim 13, wherein the battery cells are pouch cells.
